(19) United States
(12) Patent Application Publication
(10) Pub. No.: US 2012/0274564 A1
(43) Pub. Date: Nov. 1, 2012

(54) Activity Sensing Using Piezoelectric Sensors for Ultra Low Power Operation of Devices with Significant Inactivity Time

(75) Inventors: Mark Stephen Cronjaeger, Dallas, TX (US); Eduardo Bartolome, Dallas, TX (US)

(73) Assignee: TEXAS INSTRUMENTS INCORPORATED, Dallas, TX (US)

(21) Appl. No.: 13/098,263

(22) Filed: Apr. 29, 2011

(51) Int. Cl. G06F 3/033; G06F 15/00; G06F 1/32

(52) U.S. Cl. 345/166; 713/323; 713/324; 702/150

(57) ABSTRACT

A system and method for reducing power consumption in an inactive device. Based upon inputs received from one or more sensors, a processor in a device determines that the device has not moved or has been inactive for a predetermined period. One or more components of the device are placed in an inactive state or in a sleep mode when the device has been inactive for the predetermined period. The inactive state or sleep mode requires less power consumption by the components than an active mode of operation. A piezoelectric sensor in the device is used to detect movement. The piezoelectric sensor provides an input signal to the processor upon detecting movement of the device. The one or more components are placed in the active mode in response to the input signal.

### TECHNICAL FIELD

Embodiments of the invention are directed, in general, to sensing movement of devices using piezoelectric sensors and, more specifically, to conserving power in such devices during periods of inactivity.

### BACKGROUND

Numerous moveable devices that use battery power must maintain an “always on” state so that they are ready for use when desired by a user. However, such devices may undergo long periods of inactivity between uses. During these inactive periods, the devices waste power by continually monitoring or attempting to detect motion that does not occur. For example, a wireless optical pointing device, such as an optical computer mouse, at a workstation may be used at intervals during an eight-hour work day, but then sits idle for sixteen straight hours until the work day starts again. The wireless optical mouse may undergo other long periods of inactivity during the day, such as during a user's lunch break. During these inactive periods, the mouse cannot shut off or it will not be able to sense inputs when the user returns. As a result, the mouse expends wasted energy during most of the day.

Similarly, equipment asset tags may be used to provide location information for high value or critical equipment, such as medical or monitoring equipment in a hospital. The location of the equipment must be readily identifiable for use in an emergency or when otherwise needed. Asset tags or transponders may be affixed to the equipment to transmit location information to a central monitoring system. Such equipment is often left in one location for extended times, such as in a surgical suite or patient room. Continuous updating of the equipment's location is not needed when the equipment remains in the same location, but the device must be capable of sending updates at any time in the event of movement. In some such devices, a switch on the asset tag is place so that the switch must be activated when the equipment is moved, thereby causing the asset tag to send updated location information. However, the use of such switches limits the placement of the asset tags to a few locations on the equipment.

### SUMMARY OF THE INVENTION

Embodiments of the devices disclosed herein comprise a motion-sensing device that detects activity using a very low power method and thereby significantly extends battery life. As a result, the useful life of the battery powered devices, such as infrequently used wireless devices, may be extended. In one embodiment, activity is sensed using piezoelectric sensors and very low power signal conditioning.

In a wireless mouse, when the user is not using the mouse, the mouse may enter a standby mode but cannot completely turn off because it must periodically determine if motion has occurred. The mouse's optical system, which may include a light emitting diode (LED) and a camera, for example, is enabled at frequent intervals to detect any movement. Using the piezoelectric sensor described herein, the wireless mouse may remain in an inactive state until the mouse is actually moved.

In another embodiment, active radio frequency (RF) asset tags are placed on expensive and/or critical equipment, such as medical equipment in a hospital. The RF asset tags allow users to keep track of the equipment's location. To save power, the asset tags may transmit position only when the equipment is moved. Accelerometers, such as Micro-Electro-Mechanical Systems (MEMS)-based accelerometers, may be used for detection such motion. However, MEMS accelerometers have a high power consumption compared to the piezoelectric-based sensors used in the embodiments described herein.

Motion-sensing devices using piezoelectric sensors make it possible to reduce power consumption of the device to microwatts during an inactive state or sleep mode. This drop in power consumption enables the use of smaller, rechargeable batteries or even primary cells, thereby reducing costs through the elimination of recharging equipment and potentially eliminating the need to ever change the battery.

### BRIEF DESCRIPTION OF THE DRAWINGS

Having thus described the invention in general terms, reference will now be made to the accompanying drawings, wherein:

FIG. 1 illustrates an exemplary embodiment of a wireless optical mouse that incorporates a piezoelectric sensor to control or limit power consumption;

FIG. 2 illustrates an exemplary embodiment of a wireless location asset tag that incorporates a piezoelectric sensor to control or limit power consumption;

FIG. 3 is a high level block diagram of a piezoelectric sensor circuit for controlling power consumption during periods of inactivity;

FIG. 4 is a block diagram of another embodiment of a piezoelectric sensor circuit; and

FIG. 5 is a block diagram of a further embodiment of a piezoelectric sensor circuit.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

A piezoelectric sensor uses a material that produces a voltage or an electric charge when the material is squeezed or stretched or otherwise subjected to a mechanical stress or pressure. Piezoelectric materials include piezoelectric ceramics and crystal materials. Piezoelectric sensors are active sensors because no external source of power is required to generate an output from the piezoelectric material. Piezoelectric sensors are often used in pedometers to detect a user's motion and to measure the distance that the user travels. Unlike MEMS accelerometers, piezoelectric sensors do not provide an output for a steady deformation or pressure, but only detect an event, such as movement, shock, or impact, when it occurs.

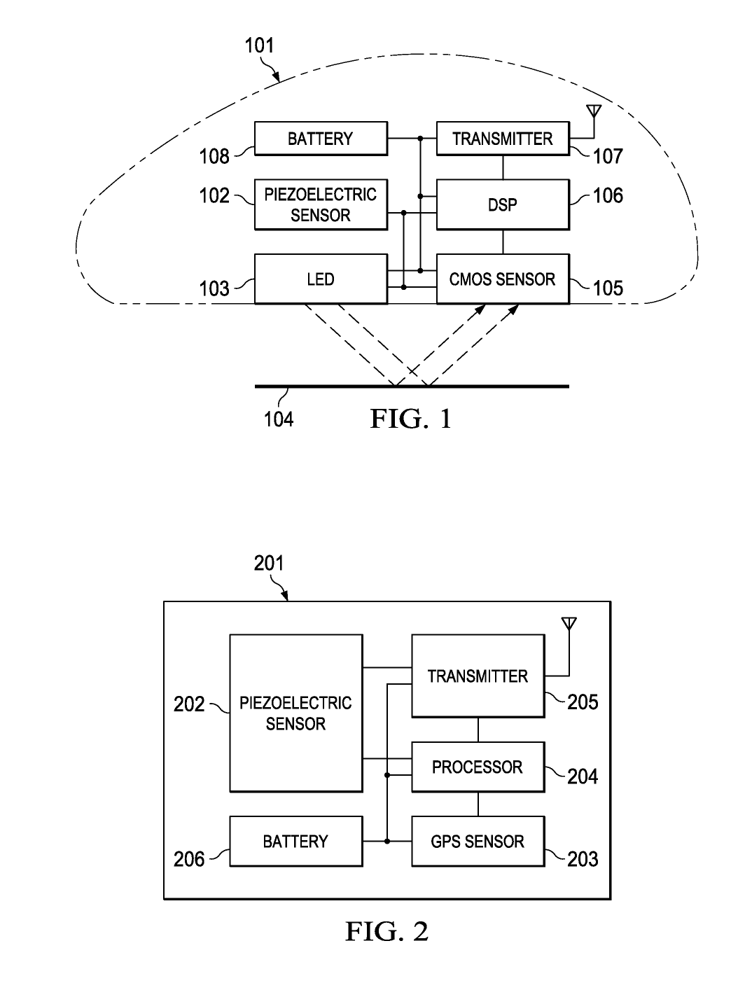

FIG. 1 illustrates an exemplary embodiment of a wireless optical mouse 101 that incorporates a piezoelectric sensor 102 to control or limit power consumption. Wireless optical mouse 101 uses a LED 103 which is typically red in color. Light emitted from LED 103 bounces light off of surface 104. In other embodiments, LED 103 may be replaced by a laser that transmits light onto surface 104. A Complementary Metal Oxide Semiconductor (CMOS) sensor 105 acts as a camera and uses the LED light to take thousands of pictures every second. CMOS sensor 105 sends each image to Digital Signal Processor (DSP) or other processor 106 for processing and analysis. Using the images from CMOS sensor 105, the DSP 106 detects patterns and images on surface 104 and identifies changes from one image to the next. DSP 106 then determines if mouse 101 has moved, and how far and how fast mouse 101 is moved. Movement information is sent from DSP 106 wirelessly via transmitter 107 to a computer (not shown) associated with mouse 101. The computer receives the movement information and coverts the data to a cursor or other icon on a display. The computer moves the displayed cursor or icon in response to the movement information from mouse 101.

Battery 108 is used to power mouse 101. LED 103 and CMOS sensor 105 must be on continuously or almost continuously to detect when mouse 101 is moved. Because mouse 101 must always be available to the user, LED 103 and CMOS sensor 105 cannot completely turn off. Instead, when movement has not been detected by DSP 106 for a predetermined period of time, such as a certain number of seconds, LED 103 and CMOS sensor 105 may be put into an inactive state or a sleep mode for a brief period, such as another number of seconds. However, LED 103 and CMOS sensor 105 must be automatically activated at short intervals to take additional pictures of surface 104 and to determine if mouse 101 has been moved or is moving. This continued operation of LED 103 and CMOS sensor 105 during long periods of no movement drains battery 108 unnecessarily.

Using piezoelectric sensor 102, LED 103 and CMOS sensor 105 may remain in a sleep mode until actual movement of mouse 101 occurs. Piezoelectric sensor 102 may control LED 103 and CMOS sensor 105 directly, and/or may control DSP 106. In one embodiment of mouse 101, DSP 106 may be responsible for determining when mouse 101 may enter a sleep mode if no motion has been sensed for a predetermined period. Although LED 105 and CMOS sensor 105 may be deactivated during the sleep mode, DSP 106 must remain active during the sleep mode to determine when to reactivate LED 103 and CMOS sensor 105 to take monitor surface 104 for motion.

Piezoelectric sensor 102 may be used to control DSP 106 during the sleep mode, which would allow DSP 106 to be at least partially inactive during the sleep mode. When mouse 101 has been inactive for the predetermined period, DSP 106 may command LED 103 to turn off or to stop illuminating surface 104 and/or may command CMOS sensor 105 to stop capturing images of surface 104. Alternatively, DSP 106 may turn off the power to the LED 103 and/or CMOS sensor 105 to force the components into a sleep mode. DSP 106 may then enter an inactive or sleep mode. At a minimum, DSP 106 may cease processing image data from CMOS sensor 105 during the sleep mode. When a user moves mouse 101 at some later time, which may be seconds, hours or days after the sleep mode has begun, piezoelectric sensor 102 will detect the motion and will notify DSP 106 that such motion occurred. DSP 106 then exits the sleep or inactive mode and commands LED 103 and CMOS sensor 105 to begin operating again. DSP 106, LED 103 and CMOS server 105 should react to piezoelectric sensor 102 fast enough so that the user would not notice the change from an inactive state or sleep mode to an active state. Use of piezoelectric sensor 102 reduces standby current consumption compared to the power consumed by traditional methods, such as MEMS accelerometers.

Although the example used in FIG. 1 refers to an optical mouse, this example embodiment is not intended to limit the invention. It will be understood that the activity sensing piezoelectric sensors may be used with numerous devices to provide ultra-low power operation during significant inactivity time. For example, such activity sensing piezoelectric sensors may be used in a remote control device for a television, cable box, stereo or other equipment. The remote control device may enter a sleep mode after a period of inactivity. An activity sensing piezoelectric sensor in the remote controller detects motion when a user picks up the device. Upon detection of activity by the activity sensing piezoelectric sensors, the remote controller may, for example, light up a keypad and/or display and activate an IR or radio frequency transmitter in anticipation of receiving user inputs.

In another embodiment, a wireless keyboard for a computer may use the activity sensing piezoelectric sensors to detect activity, such as movement of the keyboard or keystroke inputs. The wireless keyboard, like a wireless optical mouse, must periodically check for user inputs. The activity sensing piezoelectric sensors would allow the keyboard to enter a sleep mode in which power use is significantly reduced, if not turned off. When the user beings typing or adjusts the keyboard to being typing, the activity sensing piezoelectric sensors would trigger the keyboard to return to an activate mode and activate a transmitter or other circuits needed during use.

FIG. 2 illustrates an exemplary embodiment of a wireless asset tag 201 that incorporates a piezoelectric sensor 202 to control or limit power consumption. Wireless asset tag 201 may be attached to high value or critical equipment to allow a user or owner to keep track of the current location of the equipment. Wireless asset tag 201 uses Global Positioning System (GPS) sensor 203 or other device to determine the current location of tag 201. Processor 204 monitors the location information from GPS sensor 203 and determines if asset tag 201 has moved. Processor 204 provides location information to transmitter 205, which transmits the information to a remote monitor (not shown) that keeps track of the location of asset tag 201 and similar devices.

Battery 206 is used to power wireless asset tag 201 and its components. GPS sensor 203 and processor 204 must be on continuously or at least operating during regular intervals to detect when asset tag 201 is moved. Transmitter 205 must be on whenever movement is detected in order to transmit updated location information. Because asset tag 201 must always be monitoring movement, GPS sensor 203 and processor 204 cannot completely turn off. Instead, when movement has not been detected by processor 204 for a predetermined period of time, such as a certain number of seconds, asset tag 201 may be put into an inactive state or a sleep mode for a brief period, such as another number of seconds. However, asset tag 201 must be automatically activated at short intervals to determine if mouse 101 has been moved or is moving. This continued operation of GPS sensor 203, processor 204, and transmitter 205 during long periods of no movement drains battery 206 unnecessarily.

Using piezoelectric sensor 202, GPS sensor 203, processor 204, and transmitter 205 may remain in a sleep mode until actual movement of asset tag 201 occurs. Piezoelectric sensor 202 may control GPS sensor 203 directly, and/or may control or activate processor 204. In one embodiment, piezoelectric sensor 202 may be used to control processor 204 during the sleep mode, which would allow processor 204 to be at least partially inactive during the sleep mode. When the asset tag 201 has not changed location for the predetermined period, processor 204 may command GPS sensor 203 and transmitter 205 to turn off and to enter an inactive mode. Alternatively, processor 204 may remove the power to GPS sensor 203 and transmitter 205 to force the asset tag into a sleep mode. When the equipment associated with asset tag 201 moves at some later time, which may be seconds, hours or days after the sleep mode has begun, piezoelectric sensor 202 will detect the motion and will activate processor 204. Processor 204 then exits the sleep or inactive mode and commands GPS sensor 203 and transmitter 205 to begin operating again.

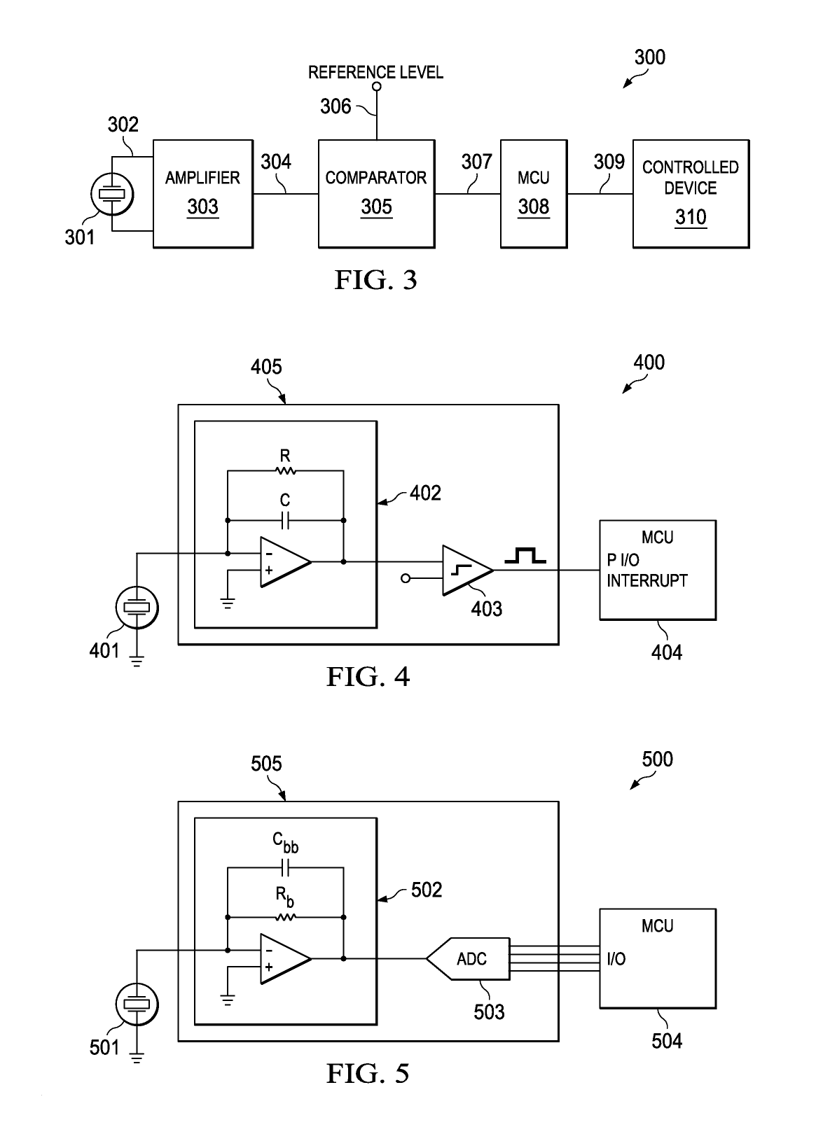

FIG. 3 is a high level block diagram of a piezoelectric sensor circuit 300 for controlling power consumption during periods of inactivity. Piezoelectric sensor 301 may be a ceramic or crystal piezoelectric device that generates a charge 302 when physically deformed, accelerated, or moved. The charge 302 generated in piezoelectric sensor 301 is input to amplifier 303, which amplifies the charge 302 to create an output signal 304 to comparator 305. Comparator 305 compares the amplifier output 304 to a reference level 306 and determines whether a signal pulse has been generated. Comparator 305 generates a binary or multilevel output signal 307 that is put to microcontroller (MCU) 308. The input to MCU 308 from comparator 304 may be received at an I/O or interrupt port(s). Upon detection of the input signal 307, MCU 308 enters an active state and provides control signals 309 to controlled device 310.

The controlled device may be a transmitter, an LED or CMOS sensor in a wireless optical mouse, or a GPS sensor in a wireless asset tag, for example. It will be understood that any device may be controlled by MCU in response to movement detected using piezoelectric sensor 301.

The components of piezoelectric sensor circuit 300 may be discrete components or grouped in different combinations as required by different applications. For example, amplifier 303 and comparator 305 may be constructed as a front end for MCU 308 and may be constructed on a single silicon substrate with MCU 308. Piezoelectric sensor 301 may be a separate discrete ceramic device that is coupled to amplifier 303.

In another embodiment, the charge sensing circuit may be embedded in an MCU either with an internal piezoelectric sensor or an external piezoelectric sensor.

FIG. 4 is a block diagram of another embodiment of a piezoelectric sensor circuit 400. Piezoelectric sensor 401 is coupled to charge amplifier 402. Charge is developed in piezoelectric sensor 401 when the sensor moved and/or when pressure is applied to the sensor. The charge from piezoelectric sensor 401 is input to charge amplifier 402 where it is amplified to create an output signal. The output of charge amplifier 402 is coupled to comparator 403, which determines if the amplifier output signal is above a reference level. When the amplifier output signal is determined to be above the reference level, then comparator 403 outputs a pulse corresponding to the event detected by piezoelectric sensor 401. The output of comparator 403 is a binary signal that is coupled to microcontroller 404. The output from comparator 403 may be provided to an interrupt port or input/output (I/O) port on microcontroller 404.

In one embodiment, charge amplifier 402 and comparator 403 are constructed on chip 405, which may be part of microcontroller 404 or may be a separate device. For example, piezoelectric sensor 401 may be a separate device that is coupled to chip 405. In another embodiment, the components of circuit 400 may be embodied on a single package with microcontroller 404.

FIG. 5 is a block diagram of a further embodiment of a piezoelectric sensor circuit 500. Piezoelectric sensor 501 is coupled to transimpedance amplifier 502. Charge is developed in piezoelectric sensor 401 when the sensor moved and/or when pressure is applied to the sensor. The output from piezoelectric sensor 501 is input to transimpedance amplifier 502 which amplifies the sensor signal to create an amplifier output signal. The output of transimpedance amplifier 502 is coupled to analog-to-digital converter (ADC) 503, which converts the amplifier output signal to discrete digital signals, such as signal that correspond to the amplitude of the signal created in amplifier 502. ADC 503 outputs signals corresponding to the event detected by piezoelectric sensor 501. The output signals from ADC 503 are coupled to microcontroller 504. The output from ADC may be provided to interrupt ports or I/O ports on microcontroller 504.

In one embodiment, transimpedance amplifier 502 and ADC 503 are constructed on chip 505, which may be part of microcontroller 504 or may be a separate device. For example, piezoelectric sensor 501 may be a separate device that is coupled to chip 505. In another embodiment, the components of circuit 500 may be embodied on a single package with microcontroller 504.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A pointing device, comprising:
a light source for illuminating a surface on which the device is resting;
an image sensor for capturing images of the surface illuminated by the light source;
a processor coupled to the image sensor, the processor receiving image data from the image sensor, wherein the processor uses the image data to identify movement of the device;
a power source providing power to the light source, the image sensor and the processor; and
a piezoelectric sensor circuit coupled to the processor, the piezoelectric sensor circuit adapted to detect movement of the device and to generate a signal when the movement is detected.

2. The pointing device of claim 1, wherein the processor enters an inactive state when no movement is detected using the image data for a predetermined period, and wherein the processor enters an active state upon receipt of the signal from the piezoelectric sensor circuit.

3. The pointing device of claim 1, wherein the processor enters an inactive state when the device is not used for a predetermined period, and wherein the processor enters an active state upon receipt of the signal from the piezoelectric sensor circuit.

4. The pointing device of claim 1, wherein the processor causes components of the device to enter an inactive state when the device is not used for a predetermined period, and wherein the components are returned to an active state upon receipt of the signal from the piezoelectric sensor circuit at the processor.

5. The pointing device of claim 4, wherein the light source is turned off during the inactive state.

6. The pointing device of claim 4, wherein the image sensor stops capturing images of the surface during the inactive state.

7. The pointing device of claim 4, wherein power is removed from the components of the device during the inactive state.

8. The pointing device of claim 4, further comprising:
a transmitter circuit coupled to the processor, the transmitter circuit transmitting movement data to a remote device, wherein the transmitter is turned off during the inactive state.

9. An asset tracking device, comprising:
a location sensor for identifying a current location of the device;
a processor coupled to the location sensor, the processor receiving location data from the location sensor, wherein the processor uses the location data to identify movement of the device;
a power source providing power to the location sensor and the processor; and
a piezoelectric sensor circuit coupled to the processor, the piezoelectric sensor circuit adapted to detect movement of the device and to generate a signal when the movement is detected.

10. The asset tracking device of claim 9, wherein the processor enters an inactive state when no movement is detected using the location data for a predetermined period, and wherein the processor enters an active state upon receipt of the signal from the piezoelectric sensor circuit.

11. The asset tracking device of claim 9, wherein the processor enters an inactive state when the device is not used for a predetermined period, and wherein the processor enters an active state upon receipt of the signal from the piezoelectric sensor circuit.

12. The asset tracking device of claim 9, wherein the processor causes components of the device to enter an inactive state when the device is not used for a predetermined period, and wherein the components are returned to an active state upon receipt of the signal from the piezoelectric sensor circuit at the processor.

13. The asset tracking device of claim 12, wherein the location sensor is turned off during the inactive state.

14. The asset tracking device of claim 12, wherein power is removed from the components of the device during the inactive state.

15. The asset tracking device of claim 12, further comprising:
a transmitter circuit coupled to the processor, the transmitter circuit transmitting movement data to a remote device, wherein the transmitter is turned off during the inactive state.

16. A method, comprising:
determining, based upon inputs received from one or more sensors at a processor in a device, that the device has been inactive for a predetermined period;
placing one or more components of the device into an inactive mode of operation, the inactive mode requiring less power by the components than an active mode of operation;
providing an input signal to the processor upon detecting movement of the device using a piezoelectric sensor; and
placing the one or more components in the active mode in response to the input signal.

17. The method of claim 16, wherein the one or more components comprise a transmitter circuit.

18. The method of claim 16, wherein the device is a wireless optical pointing device, and the one or more components comprise a light source and a light sensor.

19. The method of claim 16, wherein the device is a wireless asset tag, and the one or more components comprise a location sensor.

20. The method of claim 16, wherein the one or more components placed into an inactive mode includes the processor.

21. A microcontroller sensor circuit, comprising:
a piezoelectric sensor that generates a charge when physically deformed, accelerated, or moved;
an amplifier coupled to the piezoelectric sensor and having an input adapted to receive the charge, the amplifier amplifying the charge to create an output signal;
a comparator coupled to an output of the amplifier circuit and adapted to the receive the output signal, the comparator further adapted to compare the output signal to a reference level and to determine whether a signal pulse has been generated by the piezoelectric sensor, the comparator generating a comparator output signal; and
a microcontroller receiving the comparator output signal, the microcontroller adapted to enter an active state upon detection of the comparator output signal.

22. The microcontroller sensor circuit of claim 21, wherein the microcontroller receives the comparator output signal at an I/O or interrupt port.

23. The microcontroller sensor circuit of claim 21, wherein the comparator output signal is a binary signal.

24. The microcontroller sensor circuit of claim 21, wherein the comparator output signal is a multilevel signal.

25. The microcontroller sensor circuit of claim 21, wherein the amplifier, the comparator, and the microcontroller are all located on a single chip, and further comprising an input adapted to receive the charge from the piezoelectric sensor.
